(19) United States
(12) Patent Application Publication
(10) Pub. No.: US 2016/0037509 A1
(43) Pub. Date: Feb. 4, 2016

(54) TECHNIQUES TO REDUCE BANDWIDTH USAGE THROUGH MULTIPLEXING AND COMPRESSION

(71) Applicant: ONAVO Mobile Ltd., Menlo Park, CA (US)

(72) Inventors: Roi M. Tiger, Tel Aviv (IL); Guy Rosen, Sunnyvale, CA (US); Gadi Eliashiv, Ramat Gan (IL)

(73) Assignee: ONAVO Mobile Ltd., Menlo Park, CA (US)

(21) Appl. No.: 14/446,916

(22) Filed: Jul. 30, 2014

(51) Int. Cl. H04W 72/04; H04L 5/00; H04W 28/06

(52) U.S. Cl. CPC H04W 72/0413; H04W 28/06; H04L 5/0055; H04W 88/16

(57) ABSTRACT

Techniques to reduce bandwidth usage through multiplexing and compression are described. In one embodiment, an apparatus may comprise a local interface component and an external interface component The local interface component may be operative to receive a plurality of communication requests. The external interface component may be operative to transmit through a communication channel a multiplexing of the plurality of communication requests, the multiplexed communication requests compressed during transmission. Other embodiments are described and claimed.

### BACKGROUND

Mobile devices may use a radio network interface to perform data communications, such as to a cellular or Wi-Fi access point. Such data communications may expend the battery power of the mobile device and may incur data communication charges. Data communications may be performed using the transmission control protocol/internet protocol (TCP/IP) as part of the Internet protocol suite. The TCP/IP protocol includes a three-way handshake to establish a connection, composed of a “SYN” signal from the device initiating the connection, a “SYN-ACK” signal from the non-initiating device acknowledging the initial “SYN” signal, and an “ACK” signal from the initiating device acknowledge the “SYN-ACK” signal.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to reduce bandwidth usage through multiplexing and compression. Some embodiments are particularly directed to techniques to reduce bandwidth usage through multiplexing and compression for reduction of a mobile device's bandwidth usage. In one embodiment, for example, an apparatus may comprise a local interface component and an external interface component. The local interface component may be operative to receive a plurality of communication requests. The external interface component may be operative to transmit through a communication channel a multiplexing of the plurality of communication requests, the multiplexed communication requests compressed during transmission. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a multiplexing communication system.

FIG. 2 illustrates an operating environment internal to a client device for the multiplexing communication system.

FIG. 3 illustrates an Internet operating environment for the multiplexing communication system.

FIG. 4 illustrates an embodiment of a communication channel for the multiplexing communication system.

FIG. 5 illustrates a second embodiment of a communication channel for the multiplexing communication system.

FIG. 6 illustrates a request-and-response interaction of the multiplexing communication system.

FIG. 7 illustrates an embodiment of a logic flow for the system of FIG. 1.

FIG. 8 illustrates an embodiment of a centralized system for the system of FIG. 1.

FIG. 9 illustrates an embodiment of a distributed system for the system of FIG. 1.

FIG. 10 illustrates an embodiment of a computing architecture.

FIG. 11 illustrates an embodiment of a communications architecture.

### DETAILED DESCRIPTION

Various embodiments are directed to reducing bandwidth usage by multiplexing multiple communication transmissions into a single TCP/IP connection to a proxy server. Users of mobile devices may incur charges associated with the use of cellular data bandwidth, which may be incurred for all of their cellular data traffic or after expending a periodic (e.g., monthly) allotment of cellular data. As such, it may be desirable to limit the amount of bandwidth used in performing network requests and receiving responses to these requests.

Compression may reduce the bandwidth used in transmitting a given amount of data by exploiting the redundancy in most computer data. Many Internet transactions use structured data in which structure is imposed through descriptors, such as tags, applied to various elements of the transaction. For instance, a web request may result in a hypertext markup language (HTML) document being transmitted, with the HTML document containing a plurality of hypertext markup tags describing the structure of the document and the relationships between the content of a web page. These repeated strings may be replaced with shorter strings for transmission, with the shorter strings expanded back into the original form for use by a web application. The content of a web page may also include repetition, such as repeated words or phrases, repeated image elements, and so on. Even those elements that are already compressed—for instance image stored in the joint photograph experts group (JPEG), graphics interchange format (GIF), or other image formats—may be further compressed.

Compression algorithms may construct a compression dictionary used to translate between the source text and the compressed text, the compression dictionary providing substitutions for strings within the source text that can be used to represent those strings within a compressed encoding. Due to repetition within the source text, these substitutions may be, on average, shorter than the strings they stand in for. As such, the compressed encoding may use less space (e.g., less bits, less bytes, less words) than the source text, even when including the space used to store the compression dictionary itself. Entries in a compression dictionary provide a mapping between source strings and compression strings. Some compression algorithms may construct a dictionary that covers the entire text, while others may construct dictionaries that cover only a portion. Some algorithms may cover a portion by using a “sliding window,” in which each segment (e.g., bit, byte, word, predefined length of bytes, etc.) is compressed according to a dictionary specific to that segment. In general, some compression algorithms may achieve higher levels of compression—a greater reduction in space used to store the compressed text and therefore a greater reduction in bandwidth used to transmit the compressed text—when the dictionary covers a larger piece of text.

Messages sent over the Internet may be shorter than the minimum length for various compression algorithms that would achieve the optimal level of compression for those algorithms. For example, a hypertext transfer protocol (HTTP) request for a web page may not be of sufficient length for a compression algorithm to find as much redundancy as if additional similar text to the HTTP request were included in the text to be compressed. As such, it may be advantageous to bundle together multiple communication requests into a single package for compression, with the compressed package transmitted as a unit.

In some cases, the destination device for a message may not support compressed messages. Further, more messages might be available for bundling when messages directed to different destinations may be bundled together, rather than only bundling messages for a single destination. As such, a device may be aided by communicating through an intermediary proxy server, where the proxy server receives the bundled communication, decompresses it, and forwards the constituent messages to their ultimate destinations.

Similarly, more messages may be available for bundling, increasing the efficiency of the compression, if messages from multiple applications on a client device are bundled together. A single application on a client device may not generate sufficient network traffic to achieve the maximal degree of compression. As such, all or some of the network traffic for several or all of application on a client device may be funneled through a single network connection to a proxy server, with the network traffic sent through the single network connection compressed according to a common scheme so as to increase the efficiency of the compression. As a result, client devices may use less bandwidth in performing network tasks, increasing the speed of communication, reducing the power used in broadcasting network traffic, and reducing the cost of performing the network tasks.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

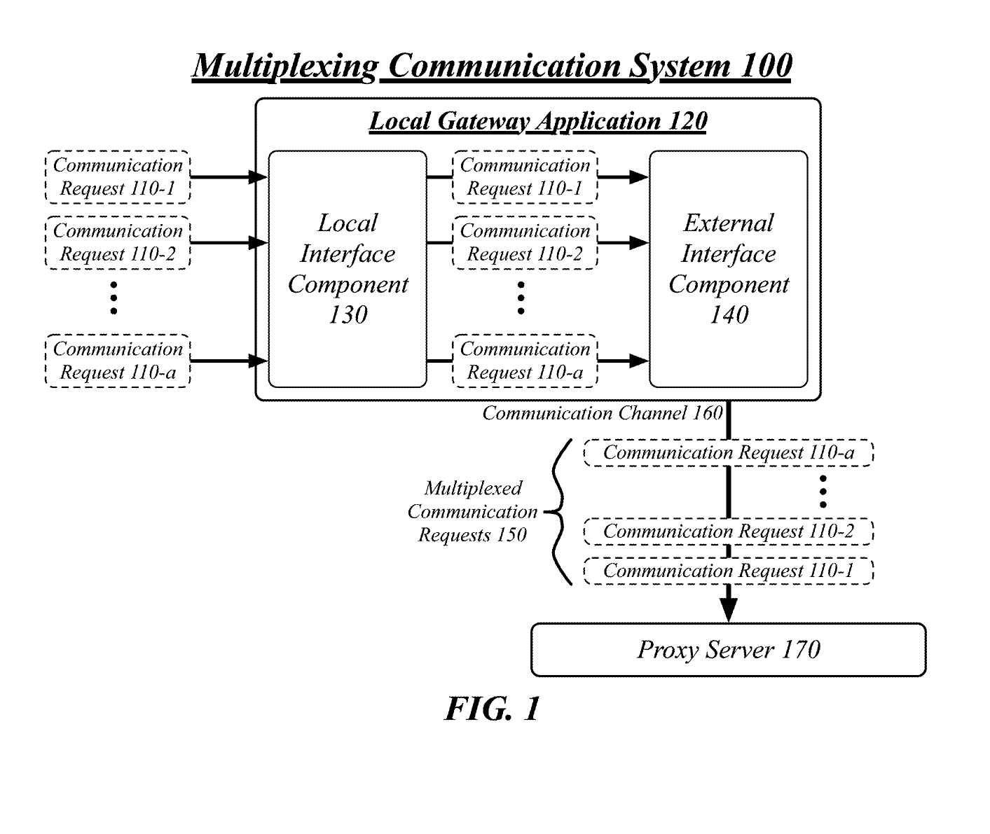

FIG. 1 illustrates a block diagram for a multiplexing communication system 100. In one embodiment, the multiplexing communication system 100 may comprise a computer-implemented system having a local gateway application 120 comprising one or more components. Although the multiplexing communication system 100 shown in FIG. 1 has a limited number of elements in a certain topology, it may be appreciated that the multiplexing communication system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122 comprising the individual components 122-1 through 122-a may include components 122-1, 122-2, 122-3, 122-4 and 122-5. The embodiments are not limited in this context.

The multiplexing communication system 100 may comprise the local gateway application 120. The local gateway application 120 may be generally arranged to manage the network traffic for a plurality of applications local to a client device, funneling the network traffic into a shared communication channel 160.

The local gateway application 120 may comprise a local interface component 130. The local interface component 130 may be generally arranged to receive a plurality of communication requests 110. The communication requests 110 may be intended for transmittal across a communication network, such as an intranet, the Internet, or via an intranet to the Internet. For instance, the communication requests 110 may be addressed to one or more destinations on the Internet and bridged to the Internet over a cellular data network.

The local gateway application 120 may comprise an external interface component 140. The external interface component 140 may be generally arranged to transmit through a communication channel 160 a multiplexing of the plurality of communication requests 110. The external interface component 140 may transmit through a communication network, such as an intranet, the Internet, or via an intranet to the Internet.

The communication channel 160 may be connected to a proxy server 170. The communication channel 160 being connected to the proxy server 170 may correspond to the communication channel 160 being a temporarily-persistent logical connection across one or more communication media allowing for the transmission of data back and forth between the external interface component 140 and the proxy server 170. The communication channel 160 may be a transmission control protocol/internet protocol (TCP/IP) connection, with the TCP/IP connection using the TCP/IP protocol to maintain persistent communication between the external interface component 140 and the proxy server 170.

The proxy server 170 may be one of a plurality of proxy servers configured for use with the local gateway application 120. The local gateway application 120 and the proxy servers including proxy server 170 may be provided by a network services provider aiding mobile users in minimizing and managing their bandwidth usage so as to increase the utility of their cellular bandwidth allocation and their mobile device in general. For example, the network services provider may distribute copies of the local gateway application 120—or, equivalently, installers for the local gateway application 120—to mobile devices via one or more application repositories. The local gateway applications may configure the mobile devices for use with the proxy servers.

In some embodiments, the network service provider may include an authorization server (or other suitable component(s)) that allows users to opt in to or opt out of having their network activities performed using the local gateway application 120 and proxy server 170, for example, by setting appropriate privacy settings. Alternatively or additionally, opt in and opt out may be performed using a local component of a client device running the local gateway application 120. In some cases, the local gateway application 120 or proxy server 170 may perform logging of user actions. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of the network service provider through blocking, data hashing, anonymization, or other suitable techniques as appropriate. Further, although this disclosure describes enforcing privacy settings in a particular manner, this disclosure contemplates enforcing privacy settings in any suitable manner using any known technique for communicating, setting, and enforcing privacy settings.

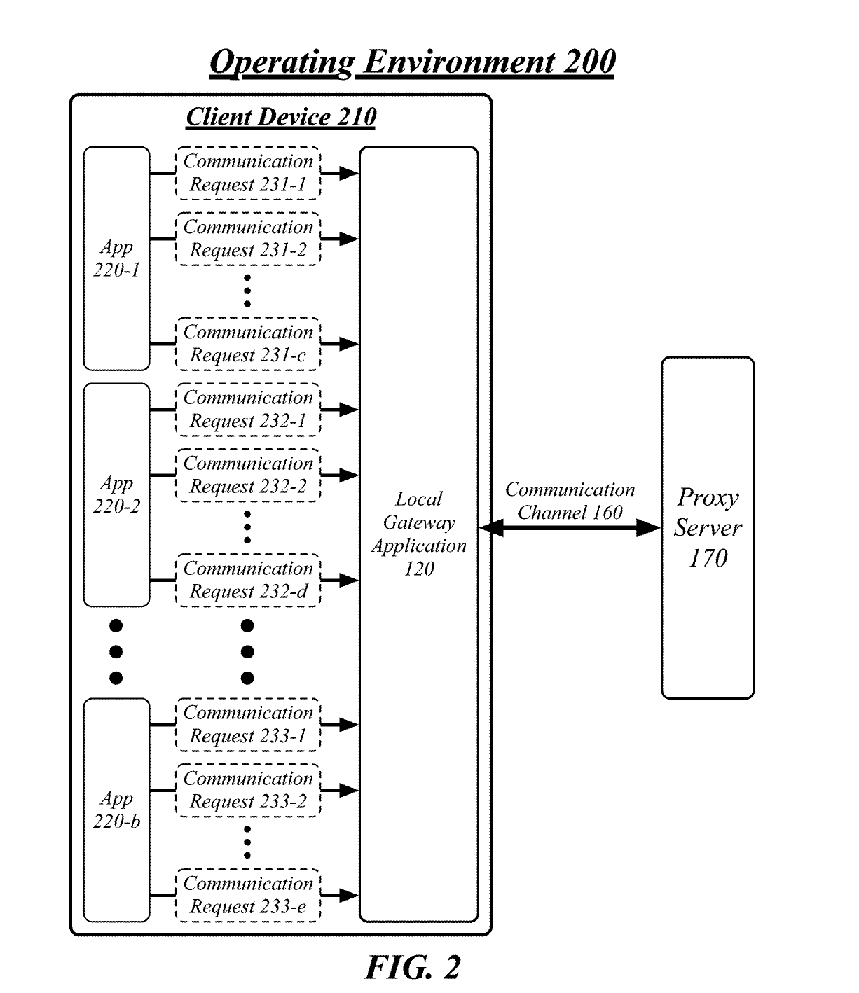

FIG. 2 illustrates an operating environment 200 internal to a client device 210 for the multiplexing communication system 100 of FIG. 1. As shown in FIG. 2, the local gateway application 120 may perform network operations on behalf of a plurality of local apps 220 on the client device 210.

The client device 210 may host a plurality of applications, or apps. In some embodiments, apps may be received from an app repository. An app repository may host a variety of mobile apps for use by various client devices. The app repository may be associated with a provider of client device 210, a provider of an operating system of client device 210, or be a third-party app repository. In some cases, a provider of proxy server 170 and local gateway application 210 may provide the third-party app repository for the distribution of local gateway application 210. Apps may be retrieved from the app repository by request of a user of the client device 210. In other embodiments, the client device 210 may come preconfigured with one or more apps. Apps retrieved from an app repository or preconfigured with client device 210 may include the location gateway application 120 and apps 220. The apps 220 and the local gateway application 120 may together comprise all of the user apps of the client device 210 or may comprise only a portion of the user apps of the client device 210.

The local gateway application 210 may be registered with an operating system of client device 210 to act as a network interface for the client device 210. The client device 210 may include a plurality of network interfaces, such as a cellular network interface, a Wi-Fi network interface, a Bluetooth network interface, and any other known network interfaces. These network interfaces may be categorized and prioritized for use with various apps running on the client device 210. The local interface component 130 provided by local gateway application 120 may be configured as a default network interface for the apps 220, such that the local gateway application 210 is used in preference over the cellular network interface, Wi-Fi network interface, or any other network interface. The local gateway application 120 may then select from among the other network interfaces of the client device 210 for the transmission and reception of network traffic out of the client device 210 and reception of network traffic into the client device 210, using the external interface component 140 to transmit and receive across one or more of the other network interfaces of the client device 210 that provide external network connectivity. The local gateway application 210 may thereby serve as a gateway between the apps 220 and the one or more external networks to which the client device 210 can connect. By serving as a gateway, the local gateway application 210 may be operative to perform communication requests on behalf of local apps 220 in conjunction with proxy server 170 using techniques to reduce bandwidth usage.

An app 220-1 of apps 220 may submit communication requests 231 to the local gateway application 210. An app 220-2 of apps 220 may submit communication requests 232 to the local gateway application 210. An app 220-b of apps 220 may submit communication requests 233 to the local gateway application 210. In general, any or all of apps 220 may submit communication requests to the local gateway application 210. The communication requests of the apps 220 may collectively comprise the communication requests 110.

Submitting a communication request to the local gateway application 210 may comprise using a network interface application programming interface (API) generally providing access to networks accessible to the client device 210. For instance, the operating system of the client device 210 may automatically select a network interface from a plurality of network interfaces according to a priority of the network interfaces. The local gateway application 120 may be the highest-priority network interface of the plurality of network interfaces. The local gateway application 120 may be of a higher priority than a cellular network interface, but be of lower priority other network interfaces (e.g., a Wi-Fi network interface) access to which is not managed by the local gateway application 120. In some embodiments, apps 220 using local gateway application 120 may first be registered with the operating system or local gateway application 120 before the local gateway application 120 is a prioritized network interface for the apps 220. A user of client device 210 may have to opt-in to a privacy policy associated with local gateway application 120 prior to local gateway application 120 being used as a network interface for apps 220.

All of the communication requests 110 comprising the combined communication requests of the plurality of apps 220 may be transmitted over a single communication channel 160. The communication requests 110 may be multiplexed into a single stream in which the communication requests 110 are iteratively broadcast across the communication channel 160. The communication requests 110 may be received at a proxy server 170.

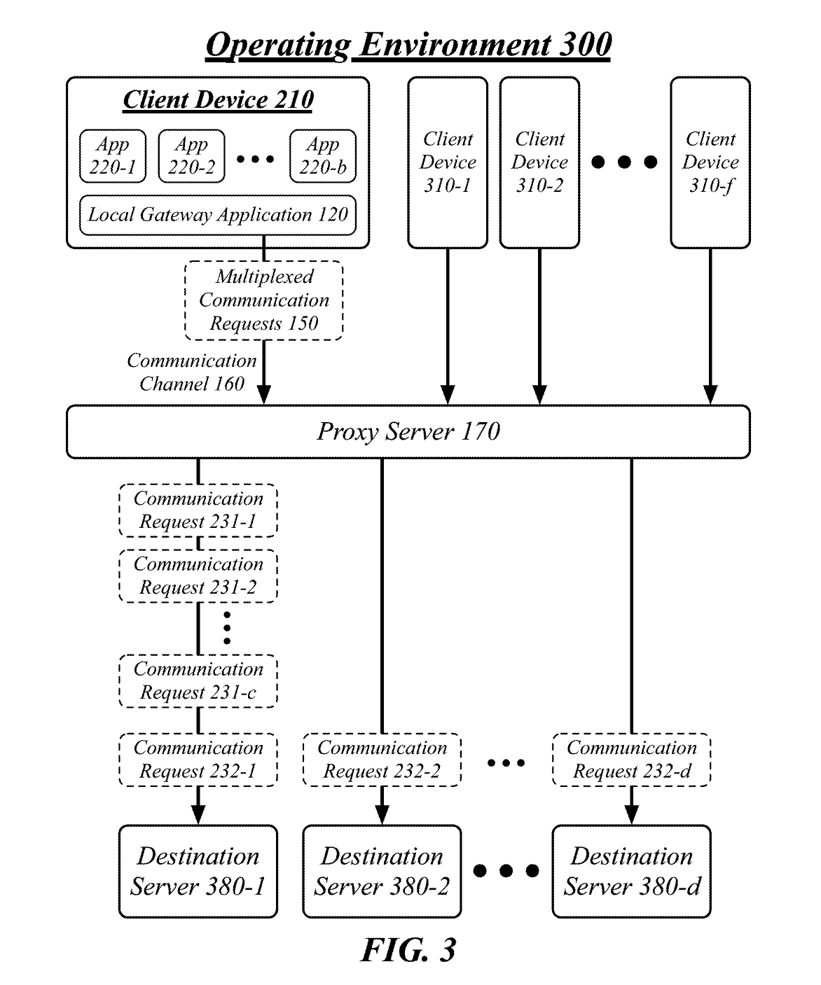

FIG. 3 illustrates an Internet operating environment 300 for the multiplexing communication system 100 of FIG. 1. As shown in FIG. 3, the client device 210 uses proxy server 170 along with a plurality of other client devices 310 in communication with a plurality of destination servers 380.

The proxy server 170 may be operative to assist a plurality of client devices, including client device 210 and client devices 210, in reducing their bandwidth usage while performing network communications. The client devices may comprise any mobile devices capable of communicating across the Internet. While in some embodiments the proxy server 170 may be selected as a proxy server in a geographic region (e.g., country, multi-country region, etc.), the proxy server 170 may generally be located anywhere accessible to the communication of the client devices. While the client devices may connect to the Internet via a cellular network provided by a cellular carrier, the proxy server 170 may be external to the cellular network and the network of the cellular carrier and instead located on the publicly-accessible Internet. However, in some embodiments, the proxy server 170 may be located at a bridge between a network of the cellular carrier and the publicly-accessible Internet, so as to minimize the communication distance and therefore the network delay in the multiplexed communication requests reaching the proxy server 170 for demultiplexing.

The proxy server 170 may be operative to assist client devices in communication with a plurality of destination servers 380. The destination servers 380 may be communicatively connected to the Internet and therefore accessible to the proxy server 170 using Internet communication protocols. The proxy server 170 may be operative to receive multiplexed communication requests from various client devices, demultiplex the multiplexed communication requests to extract individual communication requests, and perform the individual extracted communication requests on behalf of the various client devices. Where the multiplexed communication requests are compressed, the proxy server 170 may be operative to decompress the multiplexed communications requests. Where the communication requests prompt responses from the destination servers 380, the responses may be multiplexed into communication channels back to the respective client devices, compressed, and transmitted to the respective client devices.

The communication requests 110 transmitted as multiplexed communication requests 150 to the proxy server 170 may be transmitted, once demultiplexed, to different destination servers of the plurality of destinations servers 380. In a first example, the plurality of communication requests 231 from app 220-1 may all be directed to a same destination server 380-1. The plurality of communication requests 231 may comprise a plurality of web requests—such as the hypertext markup language (HTML) document for a web page and various images embedded in the web page—sent to a single web server corresponding to destination server 380-1. In a second example, the communication requests 232 from app 220-2 may all be directed to different destination servers of the plurality of destination servers 380. The plurality of communication requests 232 may comprise a different plurality of web requests—such as the hypertext markup language (HTML) document for a web page and various media embedded in the web page—wherein the media embedded in the web page is hosted on a variety of web servers corresponding to multiple destination servers in the plurality of destination servers 380.

Each of the communication requests 231-1, 231-2, 232-1, etc. of the multiplexed communication requests 150 may be transmitted as an individual communication request using an individual network connection between the proxy server 170 and the particular destination server associated with each individual communication requests. For instance, performing communication request 231-1 may involve opening a network connection to destination server 380-1 and performing communication request 231-2 may involve opening a distinct network communication to destination server 380-1. In some cases, a common network connection to destination server 380-1 may be used for communication requests 231-1 and 231-2 and may be used for all of communication requests 231. In general, the performance of communication requests 110 received as multiplexed communication requests 150 over a single communication channel 160 using a single network connection to the proxy server 170 may include the opening of a plurality of network connections and therefore communication channels with one or more destination servers.

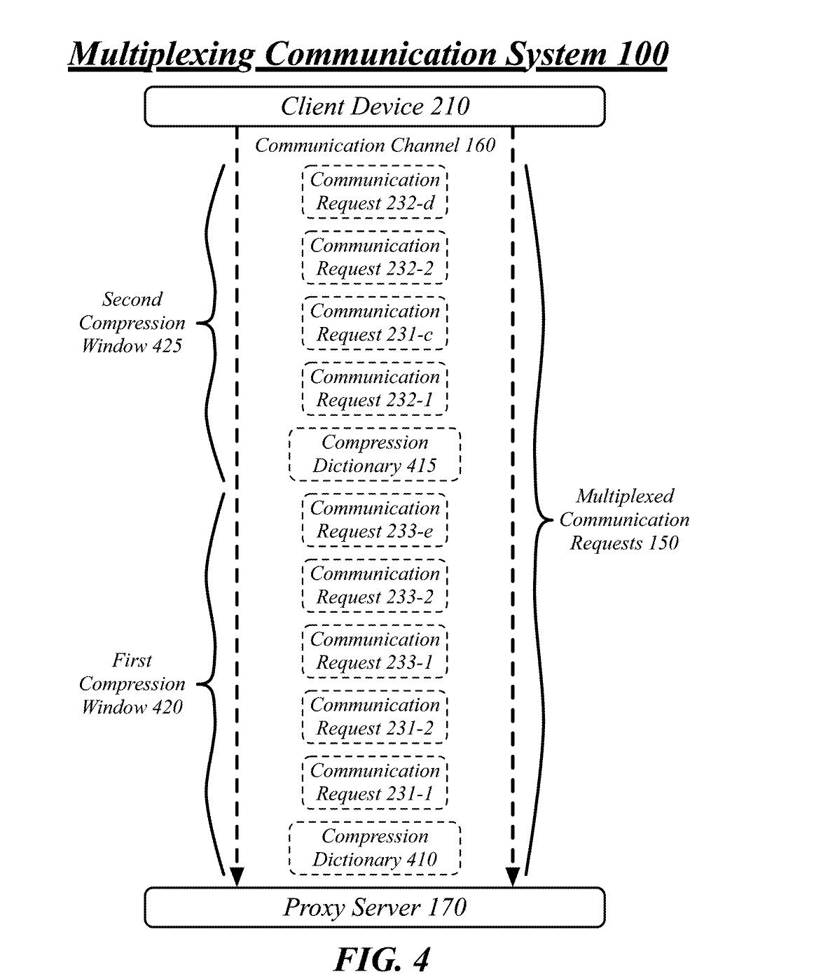

FIG. 4 illustrates a block diagram of an embodiment of a communication channel 160 for the multiplexing communication system 100 of FIG. 1. As shown in FIG. 4, the communication channel 160 is a compressed connection between the client device 210 and the proxy server 170.

All of multiplexed communication requests 150 sent through the communication channel 160 may be compressed. The multiplexed communication requests 150 may be compressed according to a common compression scheme. The external interface component 140 may be operative to compress the multiplexed communication requests 150 prior to transmission across the communication channel 160.

The compression scheme used by the external interface component 140 to compress the multiplexed communication requests 150 may use a compression dictionary. The compression dictionary may be built from or based on the multiplexed communication requests 150. The compression scheme may be one where the constructed dictionary achieves more efficient compression (i.e., more bandwidth-reducing compression) if provided a larger data set to compress, which efficiency may reach an upper limit at a particular size of data set. One or more of the individual communication requests of the multiplexed communication requests 150 may be of a size sufficiently small such that by jointly compressing them a more efficient compression is achieved by the compression scheme. For instance, a common entry in a compression dictionary may be used to compress data from two or more communication requests of the multiplexed communication requests 150. In general, multiple common entries in a compression dictionary may be used to compress data from multiple communication requests of the multiplexed communication requests 150.

In some cases, a compression scheme may operate according to compression windows, with a specific compression dictionary corresponding to a particular compression window. For instance, communication requests 231-1, 231-2, 233-1, 233-2, and 233-e may be contained within a first compression window 420 compressed by a first compression dictionary 410. Communication requests 232-1, 231-c, 232-2, and 232-d may be contained within a second compression window 425 compressed by a second compression dictionary 415. The first compression dictionary 410, the second compression dictionary 415, the first compression window 420, and the second compression window 425 may all therefore cover two or more of the plurality communication requests 110 multiplexed into the communication channel 160.

In some embodiments, a compression scheme with a sliding window may be used, such that each element of a data stream (e.g., byte, word, request) is compressed according to a dictionary defined by a relative portion of the data stream. For example, the gzip format uses the DEFLATE compression algorithm in which a sequence of bytes may be compressed by reference to an occurrence of that same sequence of bytes within the previous thirty-two kilobytes of uncompressed data, the thirty-two kilobytes being both the sliding window and the compression dictionary used to compress data. As such, a compression dictionary may correspond precisely to a compression window. In these embodiments, the compression dictionary and compression window may also cover two or more of the plurality communication requests 110 multiplexed into the communication channel 160.

In some embodiments, a compression scheme may use a preconfigured compression dictionary containing prepopulated associations between compressed text and uncompressed text. The compression scheme may rely entirely on the prepopulated associations of the compression dictionary or may add additional associations to the compression dictionary. A preconfigured compression dictionary may be specific to a type or category of communication request.

The local gateway application 120 may identify a category of communication requests being transmitted over the communication channel 160 and select a preconfigured compression dictionary based on the identified category. Alternatively or additionally, the local gateway application 120 may identify an app generating communication requests and select a preconfigured compression dictionary based on the app or a category associated with the app. For example, the local gateway application 120 may identify that a plurality of communication requests correspond to web requests, or that a requesting app corresponds to a web app, and select a web-specific compression dictionary in response. A web-specific compression dictionary may be prepopulated with associations specific to HTML documents, image formats, cascading style sheets (CSS), JavaScript Object Notification (JSON) data, and other elements of web requests. Where multiple types of communication requests and/or multiple types of apps are performing communication requests using the local gateway application 120, the local gateway application 120 may select a specific preconfigured compression dictionary based on a predominant type of communication request or requesting app or may select a specific preconfigured compression dictionary based on the first request or requesting app received that initiated the creation of communication channel 160.

In some cases, a compression dictionary may be preconfigured on both the client device 210 and the proxy server 170 prior to the establishment of communication channel 160. For instance, local gateway application 120 may come preconfigured with a plurality of compression dictionaries common to the proxy server 170. The local gateway application 120 may be periodically updated with new or modified compression dictionaries. Where a compression dictionary is modified, a delta update may be used to communicate the changes to the compression dictionary.

Where a preconfigured compression dictionary is expanded to include additional associations during the compression of the multiplexed communication requests 150, the expansion of the preconfigured compression dictionary may be transmitted as a delta update. A delta update may correspond to a formatted data package indicating modifications to a source file so as to update a previous version of a file to a new version of the file. A delta update may reduce the bandwidth used in updating a file to a new version by leveraging the existence of a previous version of the source file on the destination device. Delta updates may be compressed during transmission.

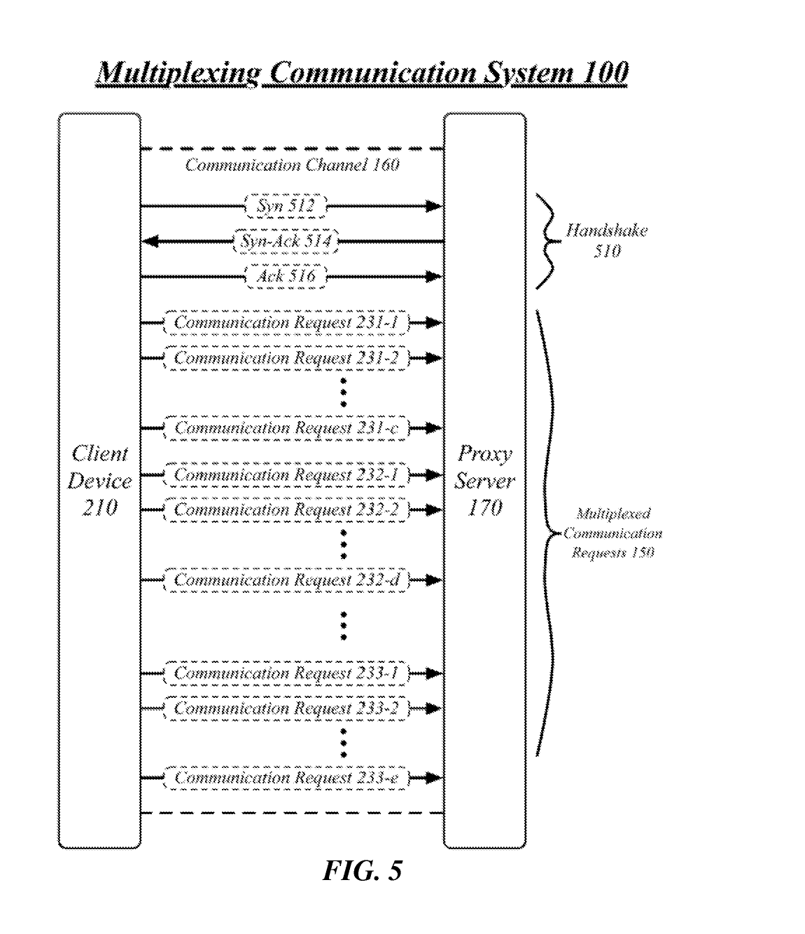

FIG. 5 illustrates a block diagram for a second embodiment of a communication channel 160 for the multiplexing communication system 100 of FIG. 1. As shown in FIG. 5, the communication channel 160 is a persistent TCP/IP connection between the client device 210 and the proxy server 170.

A TCP/IP connection is a type of persistent connection offering reliable transport over a medium such as the Internet that does not natively provide delivery guarantees. The TCP/IP protocol include a three-part handshake 510 to establish the TCP/IP connection. In the illustrated embodiment of FIG. 5, the client device 210 is initiating the TCP/IP connection with the proxy server 170. A SYN 512 is sent from the client device 210 to the proxy server 170 demonstrating the existence of a transmission path from the client device 210 to the proxy server 170 and requesting the establishment of the TCP/IP connection. A SYN-ACK 514 is sent from the proxy server 170 to the client device 210 acknowledging the SYN 512, notifying the client device 210 of the existence of the transmission path from the client device 210 to the proxy server 170, demonstrating the existence of a transmission path from the proxy server 170 to the client device 210, and accepting the request to establish a TCP/IP connection. An ACK 516 is then sent from the client device 210 to the proxy server 170 notifying the proxy server 170 of the existence of the transmission path from the proxy server 170 to the client device 210, and acknowledging the SYN-ACK 514, thereby confirming the establishment of the TCP/IP connection.

The external interface component 140 may be operative to transmit the plurality of communication requests 110 over the TCP/IP connection as the multiplexed communication requests 150 based on a single establishing of the TCP/IP connection with the proxy server 170. This may serve to reduce bandwidth used and latency by eliminating all but one of the handshakes that would otherwise be used in establishing individual TCP/IP connections between the client device 210 and proxy server 170 for each of the communication requests.

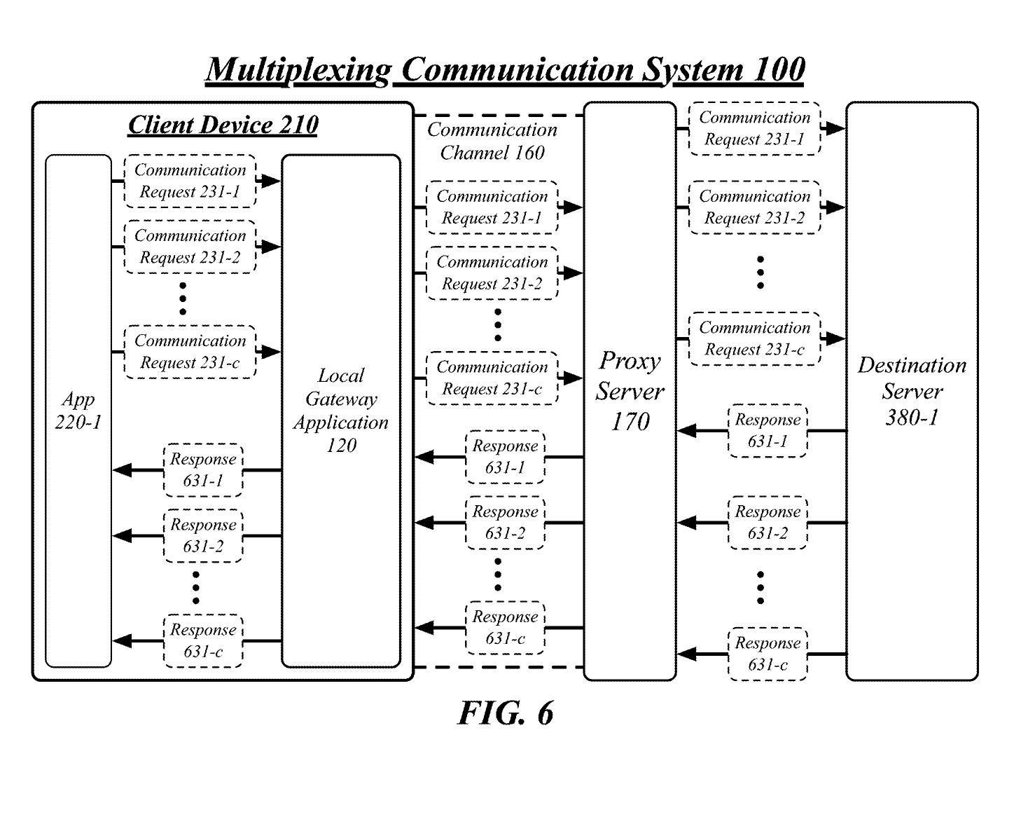

FIG. 6 illustrates a block diagram for an embodiment of a request-and-response interaction for the multiplexing communication system 100 of FIG. 1. As shown in FIG. 6, the communication channel 160 carries a plurality of communication requests 231 and a plurality of responses 631 to the requests between the client device 210 and the proxy server 170.

All or some of the communication requests 110 may generate responses from the one or more destination servers used in the performance of the communication requests 110. For instance, communication requests 231 may correspond to a plurality of requests for web resources, wherein the plurality of web resources together comprise a single multimedia webpage. Each of communication requests 231-1 through 231-c may therefore result in a response 631-1 through 631-c. It will be appreciated that the other apps generating communication requests as part of the plurality of communication requests 110 may also receive responses from various destination servers.

The responses 631 may be received by the proxy server 170 from a destination server 380-1 via one or more network connections. The proxy server 170 may multiplex the plurality of responses 631 across the communication channel 160 to the client device 210 according to the same or similar techniques described with reference to the transmission of communication requests 110 from the client device 210 to the proxy server 170.

The plurality of responses 631 may be compressed according to a compression scheme. For example, without limitation, the DEFLATE compression algorithm, the Lempel-Ziv-Markov chain (LZMA) algorithm, or the Burrows Wheeler transform (BWT) algorithm may be used. The plurality of responses 631 may be compressed using a compression window that covers two or more of the plurality of responses 631 multiplexed into the communication channel 160. The multiplexed plurality of responses 631 may be compressed using a preconfigured compression dictionary specific to the type of responses 631, to the type of communication requests 231 provoking the responses 631, or to the type of app 220-1 generating the communication requests 231 provoking the responses 631. Where a compression dictionary is used, built, updated, or otherwise generated in the compression of the communication requests 231 prior to transmission to the proxy server 170, the same built, updated, or otherwise generated compression dictionary may be used in the compression of the responses 631 prior to transmission to the client device 210.

Where communication requests 110 are received from a plurality of apps 220 running on the client device 210, the external interface component 140 may be operative to receive a multiplexed response over the communication channel 160 and demultiplex the multiplexed response into a plurality of individual responses to individual communication requests. The local interface component 130 may be operative to return the plurality of responses to the plurality of apps 220 as individual responses to the individual communication requests. As such, the apps 220 may merely perceive the submission of one or more communication requests to a network interface provided by the local interface component 130 and the reception of one or more responses, without any indication to the apps 220 that the requests and responses were multiplexed into a single communication channel 160 to a proxy server.

In different embodiments different orderings may be used for the transmission of communication requests 110 to the proxy server 170 by the client device 210. In one embodiment, the local gateway application 120 may use a first-in-first-out (FIFO) queue in which individual communication requests are transmitted in the order in which they are received. However, in other embodiments, particular requests may be prioritized according to their content or content being requested and moved to the front of the queue so as to increase the perceived responsiveness of requests. For instance, requests for web pages may prioritize requests that will resolve to the HTML content (which may include both requests for static HTML pages and requests for dynamically-generated HTML pages, such as may be produced by JavaScript, PHP, and Active Server Pages) over requests for media assets (e.g., images, audio, video) embedded in the web page so as to allow the structure of a webpage to be displayed prior to its multimedia content. Streaming content (e.g., streaming audio or streaming video) may be prioritized over static content such as web pages. Types of communication for which real-time or near-to-real-time communication are desirable, such as chat messages, may be prioritized over content for which response time is less important

In different embodiments different ordering may be used for the transmission of responses 631 to the client device 210 by the proxy server 170. In one embodiment, the proxy server 170 may use a first-in-first-out (FIFO) queue in which individual responses are transmitted in the order in which they are received. However, in other embodiments, particular responses may be prioritized according to their content and moved to the front of the queue so as to increase the perceived responsiveness of the received responses. For instance, requests for web pages may prioritize the HTML content over requests for media assets (e.g., images, audio, video) embedded in the web page so as to allow the structure of a webpage to be displayed prior to its multimedia content. Streaming content (e.g., streaming audio or streaming video) may be prioritized over static content such as web pages. Types of communication for which real-time or near-to-real-time communication are desirable, such as chat messages, may be prioritized over content for which response time is less important. The proxy server 170 may perform its own ordering of responses or may use an ordering established by the order in which the requests corresponding to the responses were received.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

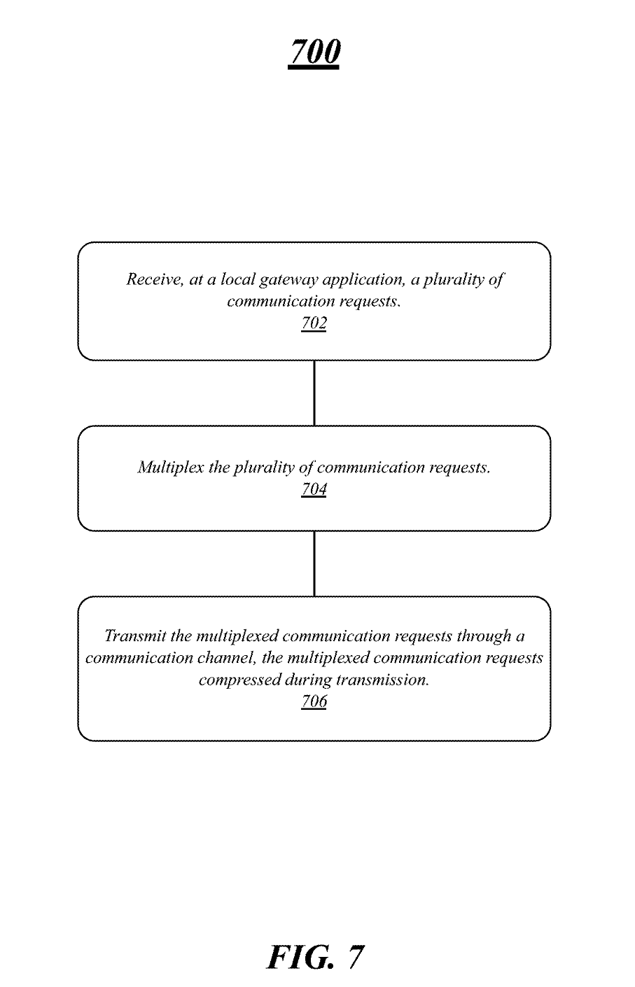

FIG. 7 illustrates one embodiment of a logic flow 700. The logic flow 700 may be representative of some or all of the operations executed by one or more embodiments described herein.

In the illustrated embodiment shown in FIG. 7, the logic flow 700 may receive, at a local gateway application 120, a plurality of communication requests 110 at block 702. The plurality of communication requests 110 may be received from a single app, such as app 220-1, or a plurality of apps 220. The plurality of communication requests 110 may correspond to a type or category of communication request. Each of the communication requests 110 may be labeled, tagged, or otherwise identified by the local gateway application 120 with a unique identifier. The local gateway application 120 may be operative to store an association between each unique identifier and an internal logical connection to an app that submitted the communication request corresponding to the unique identifier.

The logic flow 700 may multiplex the plurality of communication requests 110 into multiplexed communication requests 150 at block 704. The multiplexed communication requests 150 may be a concatenation of the plurality of communication requests 110 with additional formatting data so as to identify the individual communication requests within the multiplexed communication requests 150. The individual communication requests may be identified within the multiplexed communication requests 150 according to the unique identifier assigned to each individual communication request.

The logic flow 700 may transmit the multiplexed communication requests 150 through a communication channel 160 to a proxy server 170 at block 706. The multiplexed communication requests 150 may be compressed during transmission, such as by a common compression scheme using a compression window that covers two or more of the plurality of communication requests 110 within the multiplexed communication requests 150.

The logic flow 700 may further receive a multiplexed response over the communication channel 160. The multiplexed response may be demultiplexed into a plurality of responses according to additional formatting data used to distinguish between the different responses. Each of the responses may be received associated with a unique identifier, the unique identifier creating an association between each individual response and an individual communication request. The plurality of responses may be returned to one or more apps based on the unique identifiers. The embodiments are not limited to this example.

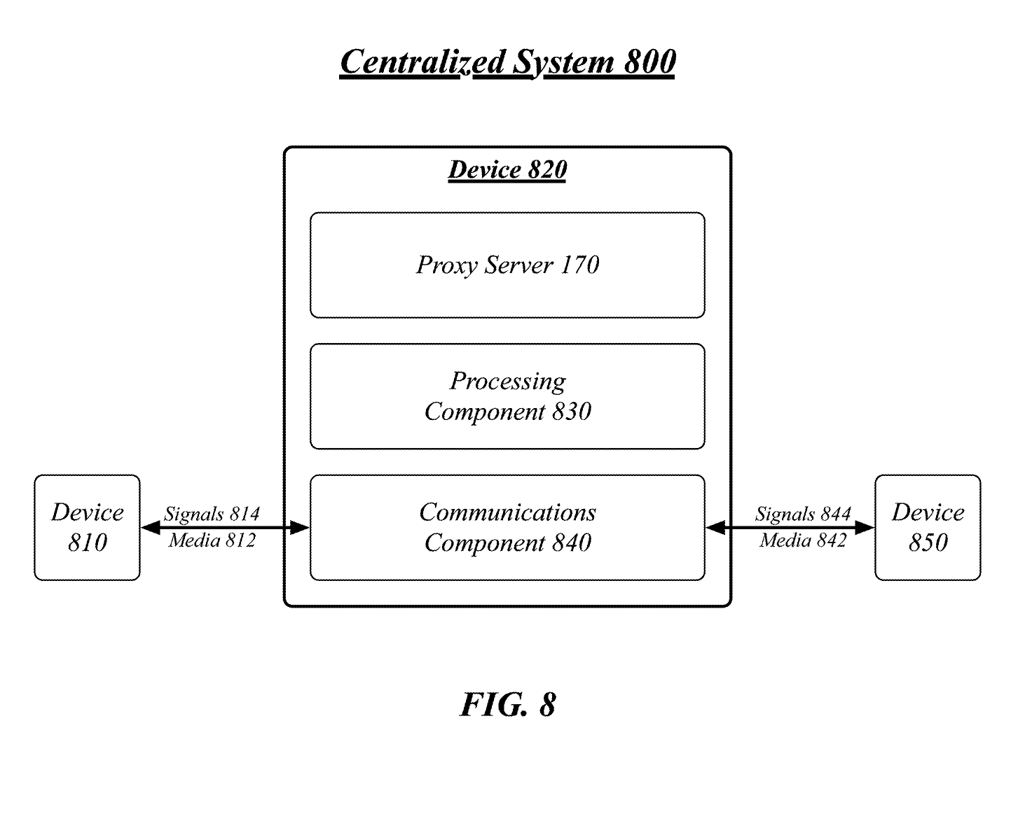

FIG. 8 illustrates a block diagram of a centralized system 800. The centralized system 800 may implement some or all of the structure and/or operations for the multiplexing communication system 100 in a single computing entity, such as entirely within a single device 820.

The device 820 may comprise any electronic device capable of receiving, processing, and sending information for the multiplexing communication system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the multiplexing communication system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the multiplexing communication system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation. The devices 810, 850 may correspond to a pair of client devices being used with the proxy server 170.

The communications signals 814 sent over communications media 812 may correspond to the establishment of a TCP/IP connection between the device 810 and the proxy server 170, the transmission of a compressed plurality of requests from the device 810 to the proxy server 170, and the transmission of a compressed plurality of responses from the proxy server 170 to the device 810. The communications signals 844 sent over communications media 842 may correspond to the establishment of a TCP/IP connection between the device 850 and the proxy server 170, the transmission of a compressed plurality of requests from the device 850 to the proxy server 170, and the transmission of a compressed plurality of responses from the proxy server 170 to the device 850. The proxy server 170 may be operative to perform the demultiplexing of requests, transmission of requests, reception of responses, and multiplexing of responses for a plurality of client devices include device 810 and device 850.

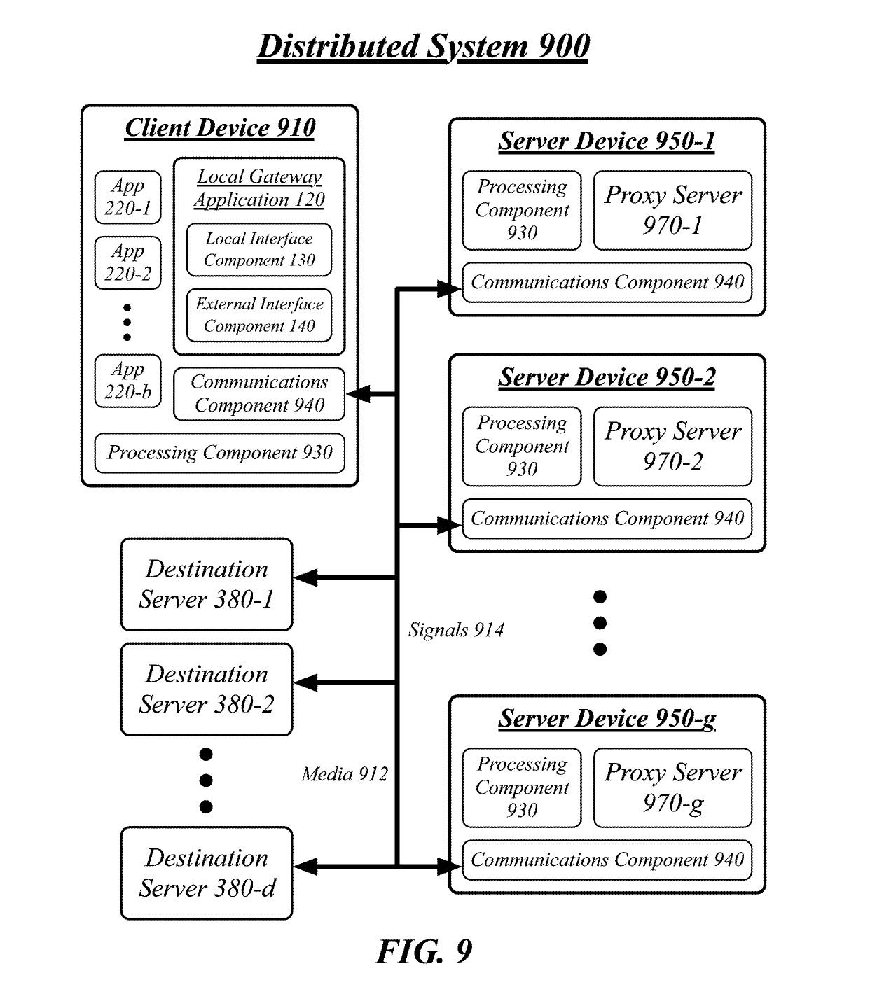

FIG. 9 illustrates a block diagram of a distributed system 900. The distributed system 900 may distribute portions of the structure and/or operations for the multiplexing communication system 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a plurality of server devices 950. In general, the client device 910 and the server devices 950 may be the same or similar to the client device 820 as described with reference to FIG. 8. For instance, the client device 910 and the server devices 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The client device 910 may comprise or employ one or more client programs that operate to perform various methodologies in accordance with the described embodiments. In one embodiment, for example, the client device 910 may implement the local gateway application 120 including the local interface component 130 and the external interface component 140 as well as a plurality of apps 220.

The server devices 950 may comprise or employ one or more server programs that operate to perform various methodologies in accordance with the described embodiments. In one embodiment, for example, the server devices 950-1 may implement a plurality of proxy devices 970. Client device 910 may communicate via a particular server device 950-1 and therefore proxy server 970-1 while other client devices communicate via other server devices and therefore other proxy servers. For instance, the proxy servers 970 may comprise elements of a proxy system supporting a large plurality of client devices, with a subset of the client devices assigned to each proxy server to distribute the load across multiple logical or physical server devices 950. The signals 914 sent over media 912 may therefore comprise the transmission of multiplexed and compressed communication requests from client devices to proxy servers 970, the transmission of demultiplexed and decompressed communication request from proxy servers to destination servers 380, the transmission of individual and uncompressed responses from destination servers 380 to proxy servers 970, and the transmission of multiplexed and compressed responses from proxy servers 970 to client devices.

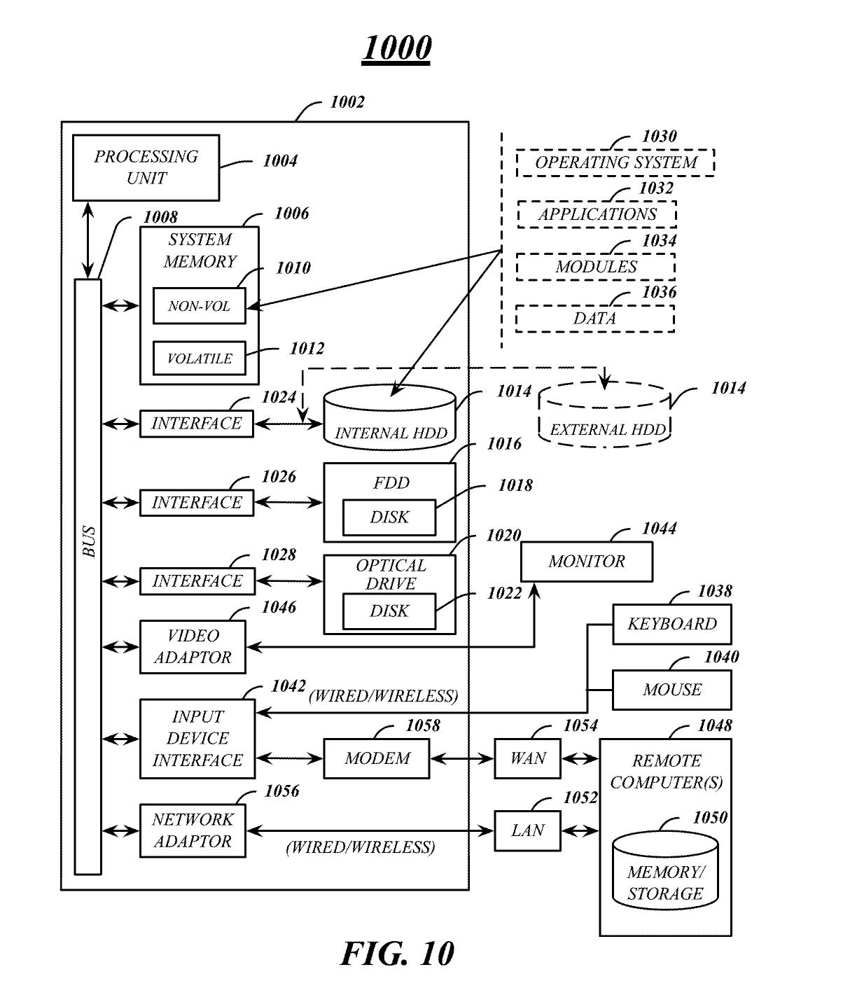

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the multiplexing communication system 100.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.10 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.10x (a, b, g, n, etc.) to provide secure, reliable, fast wireless connectivity. A Wi-Fi network can be used to connect computers to each other, to the Internet, and to wire networks (which use IEEE 802.3-related media and functions).

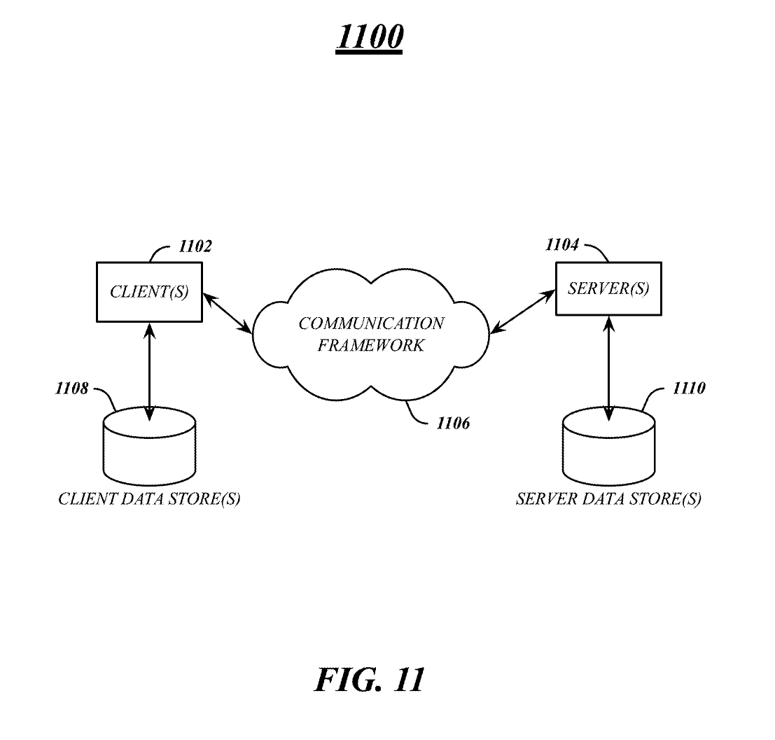

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 may implement the client device 910. The servers 1104 may implement the server device 950. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
receiving, at a local gateway application, a plurality of communication requests;
multiplexing the plurality of communication requests; and
transmitting the multiplexed communication requests through a communication channel, the multiplexed communication requests compressed during transmission.

2. The computer-implemented method of claim 1, the multiplexed communication requests compressed using a compression window that covers two or more of the plurality of communication requests multiplexed into the communication channel.

3. The computer-implemented method of claim 1, the plurality of communication requests corresponding to a type of communication request, the multiplexed communication requests compressed using a preconfigured compression dictionary specific to the type of communication request.

4. The computer-implemented method of claim 1, the communication channel connected to a proxy server, the communication channel comprising a transmission control protocol/internet protocol (TCP/IP) connection with the proxy server, further comprising:
transmitting the plurality of communication requests over the TCP/IP connection based on a single establishing of the TCP/IP connection with the proxy server.

5. The computer-implemented method of claim 1, the plurality of communication requests received from one or more applications, further comprising:
receiving a multiplexed response over the communication channel;
demultiplexing the multiplexed response into a plurality of responses; and
returning the plurality of responses to the one or more applications.

6. The computer-implemented method of claim 5, the multiplexed responses decompressed using a compression window that covers two or more of the plurality of responses multiplexed into the communication channel.

7. The computer-implemented method of claim 5, the plurality of responses corresponding to a type of response, the multiplexed responses decompressed using a preconfigured compression dictionary specific to the type of response.

8. An apparatus, comprising:
a processor circuit on a device;
a local interface component operative on the processor circuit to receive a plurality of communication requests;
an external interface component operative on the processor circuit to transmit through a compressed communication channel a multiplexing of the plurality of communication requests.

9. The apparatus of claim 8, the communication channel compressed using a compression window that covers two or more of the plurality of communication requests multiplexed into the communication channel.

10. The apparatus of claim 8, the plurality of communication requests corresponding to a type of communication request, the communication channel compressed using a preconfigured compression dictionary specific to the type of communication request.

11. The apparatus of claim 8, the communication channel connected to a proxy server, the communication channel comprising a transmission control protocol/internet protocol (TCP/IP) connection with the proxy server, further comprising:
the external interface component operative to transmit the plurality of communication requests over the TCP/IP connection based on a single establishing of the TCP/IP connection with the proxy server.

12. The apparatus of claim 8, the plurality of communication requests received from one or more applications running on the device, further comprising:
the external interface component operative to receive a multiplexed response over the communication channel and demultiplex the multiplexed response into a plurality of responses; and
the local interface component operative to return the plurality of responses to the one or more applications.

13. The apparatus of claim 12, the communication channel decompressed using a compression window that covers two or more of the plurality of responses multiplexed into the communication channel.

14. The apparatus of claim 12, the plurality of responses corresponding to a type of response, the multiplexed responses decompressed using a preconfigured compression dictionary specific to the type of response.

15. An article comprising at least one non-transitory computer-readable storage medium comprising instructions that, when executed by a processor circuit, cause a system to:
receive, at a local gateway application, a plurality of communication requests;
multiplex the plurality of communication requests;
compress the multiplexed plurality of communication requests; and
transmit the compressed multiplexed communication requests through a communication channel.

16. The article of claim 15, the communication channel compressed using a compression window that covers two or more of the plurality of communication requests multiplexed into the communication channel.

17. The article of claim 15, the plurality of communication requests corresponding to a type of communication request, the communication channel compressed using a preconfigured compression dictionary specific to the type of communication request.

18. The article of claim 15, the communication channel connected to a proxy server.

19. The article of claim 18, the communication channel comprising a transmission control protocol/internet protocol (TCP/IP) connection with the proxy server, comprising further instructions that, when executed by a processor circuit, cause a system to:
transmit the plurality of communication requests over the TCP/IP connection based on a single establishing of the TCP/IP connection with the proxy server.

20. The article of claim 15, the plurality of communication requests received from one or more applications, comprising further instructions that, when executed by a processor circuit, cause a system to:
receive a multiplexed response over the communication channel;
decompress the multiplexed response, the multiplexed response decompressed using a compression window that covers two or more of a plurality of responses multiplexed into the communication channel;
demultiplex the multiplexed response into the plurality of responses; and
return the plurality of responses to the one or more applications.
